(19) United States
(12) Patent Application Publication
(10) Pub. No.: US 2009/0024482 A1
(43) Pub. Date: Jan. 22, 2009

(54) System and method for deploying an ad widget

(75) Inventors: Donald E. Synstelien, Marietta, GA (US); Jesse Edwards, Hiram, GA (US); Frank Spitzka, Marietta, GA (US); Michael Ayers, Atlanta, GA (US)

Correspondence Address: Cantor Colburn LLP - Fox Entertainment Group, 20 Church Street, 22nd Floor, Hartford, CT, 06103, US

(73) Assignee: Fox Interactive Media, Beverly Hills, CA (US)

(21) Appl. No.: 12/218,937

(22) Filed: Jul. 18, 2008

Related U.S. Application Data
(60) Provisional application No. 60/959,982, filed on Jul. 18, 2007.

(51) Int. Cl. G06Q 30/00

(52) U.S. Cl. 705/14

(57) ABSTRACT

The present invention provides a system and method for deploying a requested widget as an advertisement on a remote device. The system comprising means for determining location of the remote device, means for determining if the requested widget to be placed on the remote device exists, and means for serving the requested widget as an advertisement to the remote device if the location is enabled for the requested widget and the requested widget exists. The present invention can also be viewed as a method for deploying a requested widget as an advertisement on a remote device. The method operates by determining location of the remote device, determining if the requested widget to be placed on the remote device exists, and serving the requested widget as an advertisement to the remote device if the location is enabled for the requested widget and the requested widget exists.

### CROSS-REFERENCE TO RELATED APPLICATION

This application claims the benefit of and priority to copending U.S. provisional application entitled, “SYSTEM FOR DEPLOYING AND TRACKING WIDGETS,” having Ser. No. 60/959,982, filed Jul. 18, 2007, and U.S. utility application entitled, “SYSTEM AND METHOD FOR PLACING A WIDGET ONTO A DESKTOP” having Ser. No. 11/837,895, filed Aug. 11, 2007, both which is entirely incorporated herein by reference.

### TECHNICAL FIELD

The present invention is generally related to software for computers and, more particularly, is related to a system and method for deploying an ad widget.

### BACKGROUND OF THE INVENTION

It is well known to serve multi media advertisements into ad servers and provide access to video, text and other media through the advertisement. It is also well known to have the advertisement expand and show additional content in the overlay, however, the ad systems of today do not provide for anything further than point to point distribution.

In computer programming, a widget is anything that can be embedded within a page of HTML, i.e. a web page. A widget adds some content to that page that is not static. Widgets are also known as modules, snippets, gadgets and plug-ins. Widgets can be written in HTML, but also in JavaScript, Flash and other scripting languages that will be run when the page is called.

A widget can also be a stand alone or self-contained chunk of code that appears as a mini-application on a user's desktop. This desktop widget runs inside a small footprint application, which resides on the user's desktop using a small desktop space and computer resources, such as the HDD and RAM. Yet, a desktop widget provides relevant information to the user in a non-intrusive manner. Basically, desktop widgets enable the user view on demand, encapsulated information from a data source(s). Ideally, a desktop widget presents personalized content, based on the user's preferences.

A desktop widget typically provides easy access to frequently used functions, information and the like or provides visual display of that information. Typical widgets include, but are not limited to, news aggregators, clocks, calculators, calendars, desktop notes and weather forecasts.

### SUMMARY OF THE INVENTION

Embodiments of the present invention provide a system and method deploying an ad widget. Briefly described, in architecture, one embodiment of the system, among others, can be implemented as follows. The system comprising means for determining location of the remote device, means for determining if the requested widget to be placed on the remote device exists, and means for serving the requested widget as an advertisement to the remote device if the location is enabled for the requested widget and the requested widget exists.

Embodiments of the present invention can also be viewed as a method for deploying a requested widget as an advertisement on a remote device. In this regard, one embodiment of such a method, among others, can be broadly summarized by the following steps. The method operates by determining location of the remote device, determining if the requested widget to be placed on the remote device exists, and serving the requested widget as an advertisement to the remote device if the location is enabled for the requested widget and the requested widget exists.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram illustrating an example of the network environment for deploying an ad widget onto an ad server of the present invention.

FIG. 2A is a block diagram illustrating an example of a server utilizing the widget system of the present invention, as shown in FIG. 1.

FIG. 2B is a block diagram illustrating an example of a remote device utilizing the remote widget system of the present invention, as shown in FIG. 1.

FIG. 3 is an example of the logical grouping of widget files in a server database and association with these groups according to the principles of the widget system of the present invention, as shown in FIGS. 1, 2A and 2B.

FIG. 4A is a flow chart illustrating an example of the operation of the widget system for the host of the present invention utilized by the server, as shown in FIGS. 2A-3.

FIG. 4B is a flow chart illustrating an example of the operation of the remote widget system of the present invention utilized by a remote device, as shown in FIG. 2B.

FIG. 5 is a flow chart illustrating an example of the operation of the widget submission process on the server that is utilized in the widget system of the present invention, as shown in FIGS. 2A and 4A.

FIG. 6A is a flow chart illustrating an example of the operation of the publish widget as an ad process on the server that is utilized in the widget system of the present invention, as shown in FIGS. 2A and 4A.

FIG. 6B is a flow chart illustrating an example of the operation of the publish widget as an ad agent on the third-party ad server that is utilized in the widget system of the present invention, as shown in FIGS. 2B and 4B.

FIG. 6C is a flow chart illustrating an example of the operation of the site owner publish widget as an ad process on a remote device that is utilized in the widget system of the present invention, as shown in FIGS. 2B and 4B.

FIG. 7A is a flow chart illustrating an example of the operation of the display process on the host that is utilized in the widget system of the present invention, as shown in FIGS. 2A and 4A.

FIG. 7B is a flow chart illustrating an example of the operation of the display agent on the remote device that is utilized in the widget system of the present invention, as shown in FIGS. 2B and 4B.

### DETAILED DESCRIPTION

The invention consists of a system and method to allow the placement of widgets into third party ad servers for the purpose of allowing end users to further distribute the widgets past the initial ad server impression allotment. This generates greater impressions of the widget than could be attained using either method alone as a result of this sharing activity and a larger number of total impressions when the viral sharing activity and the ad serving activity are combined.

One of the many functions of a widget is to provide an end user the ability to distribute an instance or copy of the widget to additional sites such as MySpace®, Facebook®, Blogger®, or other social sites, blogs and websites.

By the action of this distribution, users create a valuable opportunity to increase the number of times that other users can view or otherwise utilize the widget in question, ultimately creating potentially exponential growth. In many cases, this exponential growth is difficult to attain when only a small number of users can view the widget and be presented the opportunity to have access to the sharing functions within the widget.

The ability to serve a widget through a traditional ad server can provide the best growth as early as possible of the distributed network of widgets. This will provide a large number of initial impressions that can help generate the largest number of potential end user sharing opportunities. Furthermore, the presentation of one or more sharing points, such as a site like MySpace®, Facebook®, Blogger® or any other social network, blog or website, will allow the greatest opportunity to share the widget past the initial impression.

In allowing viral distribution through the use of a widget served via an ad server, the total number of impressions may be greater than the amount initially provided through the use of the ad server alone. This is due to the additional sharing opportunity provided by the widget that is not available through traditional ad unit (i.e. where the sharing is performed by the end users who may decide to share the widget).

When the widget is being served through an ad sever, it is essentially an advertisement, similar to a rich media advertisement. However, this is different in that no currently existing rich media advertisements have the capability to provide the end user with the ability to provide additional distribution through the use of social sharing services. However, it is not well known to provide to the viewer of an advertisement access to a method of further distribution of the advertisement past the initial ad impression. This exponential growth potential gives greater value to any advertiser utilizing a widget.

When serving the widget through the ad server, the widget can be configured, via configuration parameters that allow for users to be presented uniquely configured widgets that are targeted to their demographic. This is done through either the use of systems within the ad server or within the widget system. This allows for the widgets to be configured while being served in the ad server or after the widget has been adopted by the end user and placed on any social site, blog, web page, desktop or other device type.

The widgets served through the ad server can utilize tracking codes and/or metrics programs provided by the ad server, by the widget system or by both. Any widgets served through the widget system will seamlessly continue to be tracked for purposes of following the widget past the initial ad server impression allotment.

Once a widget is added to the widget system, it can be submitted to a third party ad server for purposes of distributing it through the ad server. From there, any site that places ad servers' ad code would be able to automatically display the widgets by using the appropriate wrapper code and parameters. Upon receiving a request for the widget, the host system would interpret received parameters and return the appropriate widget.

When the widget is displayed, it may display the social sharing services directly within the ad unit, on the widget, through another method elsewhere on the page or on the users system. This allows for further distribution of the widget to additional destinations.

Furthermore, when widgets are served as advertisements, it is sometimes beneficial to present an alternate widget while the widget is being viewed within the ad unit. Widgets served within an ad server that are a part of the widget system can provide the ability to allow the end user to share a different widget than the one which is presented to the user. One benefit for doing this might be to enable a larger call to action within the widget while it is being served as an ad. Another benefit to doing this might be to make the widget have different functionality while the widget is an ad than it may have after users have distributed it to any additional destinations.

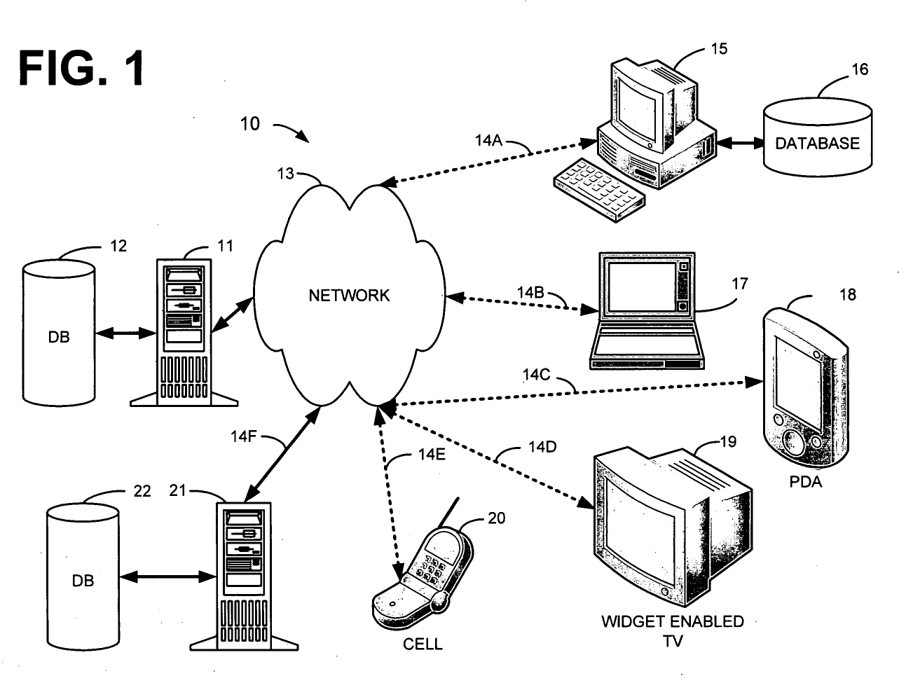

Referring now to the drawings, in which like numerals illustrate like elements throughout the several views, FIG. 1 illustrates an example of the basic components of a system 10 using the widget system used in connection with the preferred embodiment of the present invention. The system 10 includes a server 11 and the remote devices 15, 17, 18, 19, 20 or 21 that utilize the widget system of the present invention.

Each remote device 15, 17-20 has applications and can have a local database 17. Server 11 contains applications, and a database 12 that can be accessed by remote device 15, 17-20 via connections 14(A-E), respectively, over network 13. The server 11 runs administrative software for a computer network and controls access to itself and database 12. The remote device 15-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization.

The remote device 15, 17-20 may each be located at remote sites. Remote device 15, 17-20 include but are not limited to, PCs, workstations, laptops, handheld computer, pocket PCs, PDAs, pagers, WAP devices, non-WAP devices, cell phones, palm devices, printing devices and the like.

Thus, when a user at one of the remote devices 15, 17-20 desires to access the browser objects from the database 12 at the server 11, the remote device 15, 17-20 communicates over the network 13, to access the server 11 and database 12.

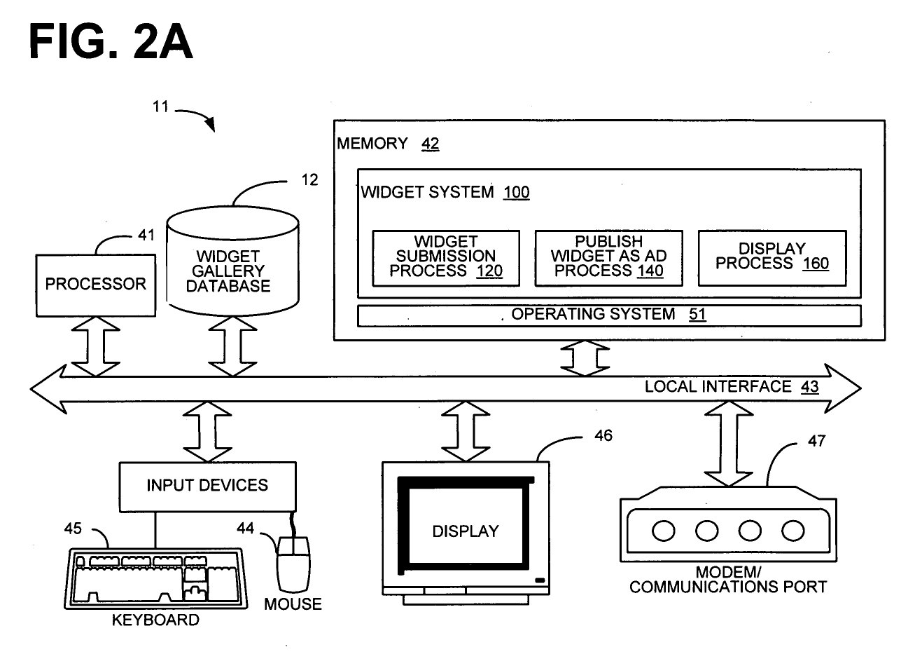

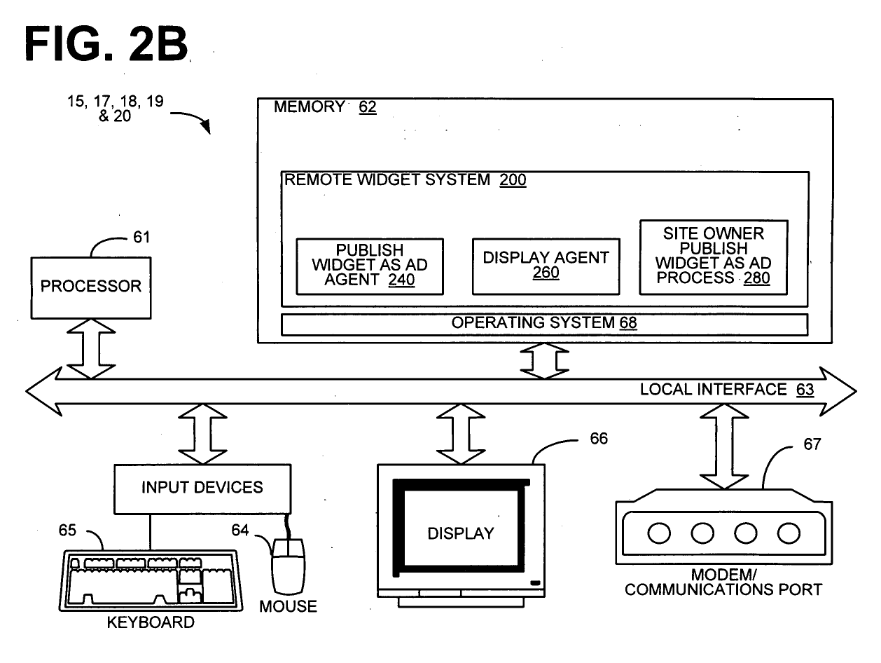

Illustrated in FIG. 2A is a block diagram demonstrating an example of server 11, as shown in FIG. 1, utilizing the widget system 100 of the present invention. Server 11 includes, but is not limited to, PCs, workstations, laptops, PDAs, palm devices and the like. Illustrated in FIG. 2B is an example demonstrating a remote devices 15, 17-20 utilizing remote widget system 200 of the present invention. The processing components of the remote devices 15 are similar to that of the description for the server 11 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 51 and the widget system 100 of the present invention. As illustrated, the widget system 100 of the present invention comprises numerous functional components including, but not limited to, the widget submission process 120, publish widget as an ad process 140 and display process 160.

A non-exhaustive list of examples of suitable commercially available operating systems 51 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, such as the widget system 100, and provides scheduling, input-output control, file and data management, memory management, and communication control and related services. However, it is contemplated by the inventors that the widget system 100 of the present invention is applicable on all other commercially available operating systems.

The widget system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 51. Furthermore, the widget system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the server 11 is activated.

When the server 11 are in operation, the processor 41 is configured to execute software stored within the memory 42, to communicate data to and from the memory 42, and to generally control operations of the server 11 are pursuant to the software. The widget system 100 and the O/S 51 are read, in whole or in part, by the processor 41, perhaps buffered within the processor 41, and then executed.

When the widget system 100 is implemented in software, as is shown in FIG. 2A, it should be noted that the widget system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The widget system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the widget system 100 is implemented in hardware, the widget system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15, 17-20, 21 that enables access to the widget system 100 of the present invention, as shown in FIG. 2A. The remote device 15 provides access to the widget or browser objects residing in database 12. The widgets or browser objects information accessed in database 12 can be provided in the number of different forms including but not limited to ASCII data, WEB page data (i.e. HTML), XML or other type of formatted data. As illustrated, the remote device 15, 17-20 and 21 includes many of the same components as server 11 described with regard to FIG. 2A. Hereinafter, the remote devices 15, 17-20 and 21 that will be referred to as remote devices 15 for the sake of brevity.

Located in memory 62 of the remote device is remote widget system 200, which includes, but is not limited to, the publish widget as an ad agent 240, display agent 260 and site owner publish ads as widget process 280. When the remote widget system 200 is implemented in software, as is shown in FIG. 2B, it can be stored on virtually any computer readable medium for use by or in connection with any computer related system or method.

In an alternative embodiment, where the remote widget system 200 is implemented in hardware, the remote widget system 200 can be implemented in the same way as described above with regard to the widget system 100 (FIG. 2A).

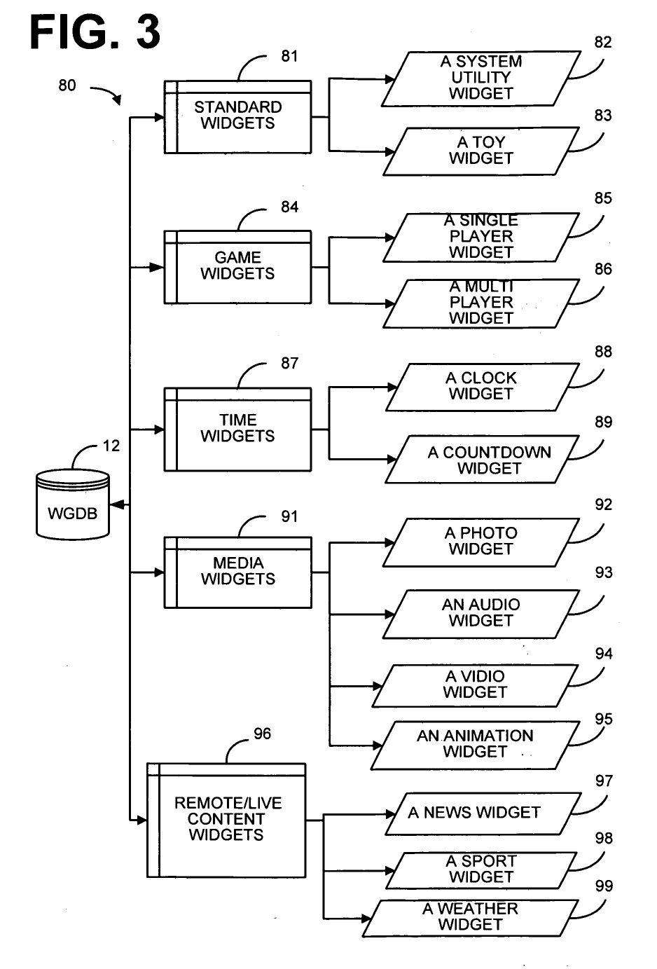

FIG. 3 is an example illustrating of the logical grouping of widget files in a database 12 and association of these files according to the widget system of the present invention, as shown in FIGS. 1, 2A and 2B. The database 12 comprises the widget database (WD) 80. The illustrated example WD 80 data comprises, but is not limited to, the groupings of standard 81, game 84, time 87, media 91 and remote/live content 96 widget types. These exemplary widget groupings furthering include exemplary subcategories, as follows. Standard widgets 81 include, but are not limited to, system utility widgets 82 and toy widgets 83. Game widgets 84 include, but are not limited to, single 85 and multiplayer 86 widget's. Time widgets 87 include, but are not limited to, clock widgets 88 and countdown to widgets 89. Media widgets 91, include, but are not limited to, photo 92, audio 93, video 94 and animation 95 widgets. And remote/live content widgets 96 include, but are not limited to, news widgets 97, sports widgets 98 and weather widgets 99. As mentioned, the widget files are stored on the widget server(s), the data about the widgets is stored in database 12. When they are downloaded by the desktop widget wrapper the desktop widget wrapper creates a widget folder and stores the downloaded widget file in that folder. In the preferred embodiment, the downloaded widget files have the suffix “.sbw”, which stands for “.SpringBoxWidget”. These .sbw files are identical to the “.swf” files that a Flash Player runs, but they may contain ActionScript code referencing the widget API; code that is not recognized nor supported by a standard flash player and therefore would do nothing if not run inside the widget windows. Further the file extension allow the widget files to be linked to the desktop client thus, double-clicking on a widget file will launch the client to open it. The difference is not in terms of the programming code and the way that it is compiled, but in that the .sbw files are using remote API commands (RAPI) to extend the functions available in a Flash Player or clip. It is understood that other suffix indicating other types of widget files may be utilized.

Some RAPI commands used are: Widget.height, Widget.width, Widget.environment, and Widget.getParameters( ). The Widget.getParameters( ) command allows the widget to pull in the parameters that are inside the web page widget wrapper. There may be more API functions. Some could allow access to the hard drive, leverage features in the platform, or change the appearance of the widget wrapper (for example, remove the close button that is part of the desktop wrapper).

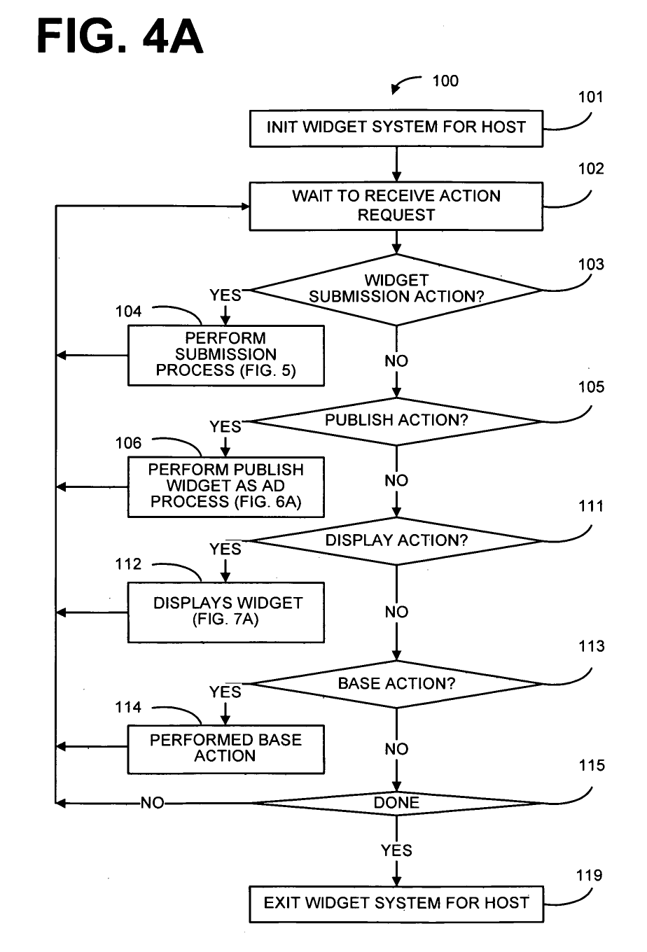

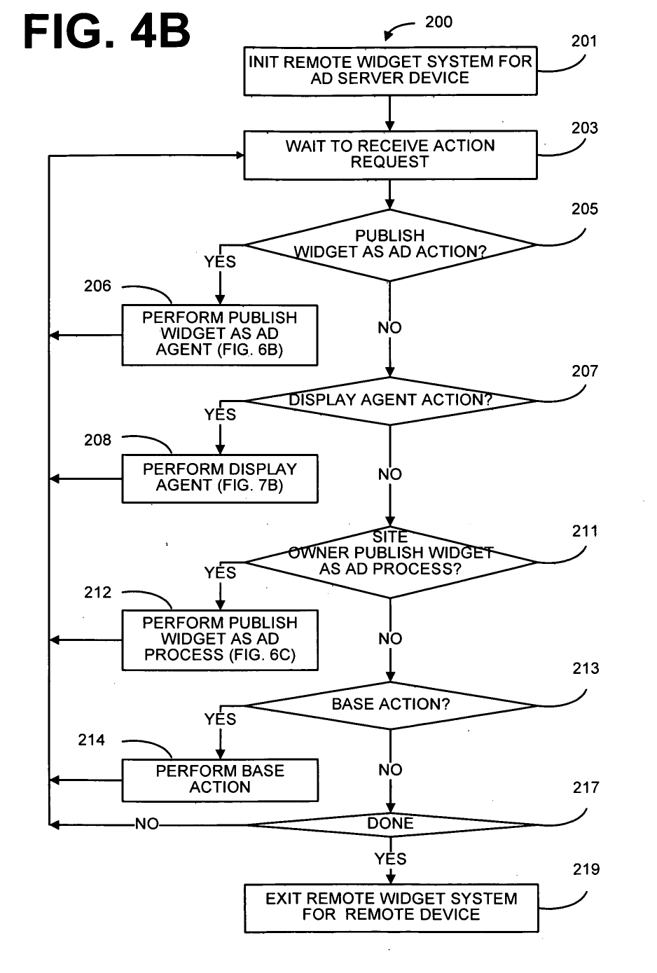

FIG. 4A is a flow chart illustrating an example of the operation of the widget system 100 of the present invention utilized by the server 11, as shown in FIG. 2A. The widget system 100 of the present invention provides instructions and data in order to create and deploy a widget as an ad.

First at step 101, the widget system 100 is initialized. This initialization includes the startup routines and processes embedded in the BIOS of the server 11. The initialization also includes the establishment of data values for particular data structures utilized in the widget system 100.

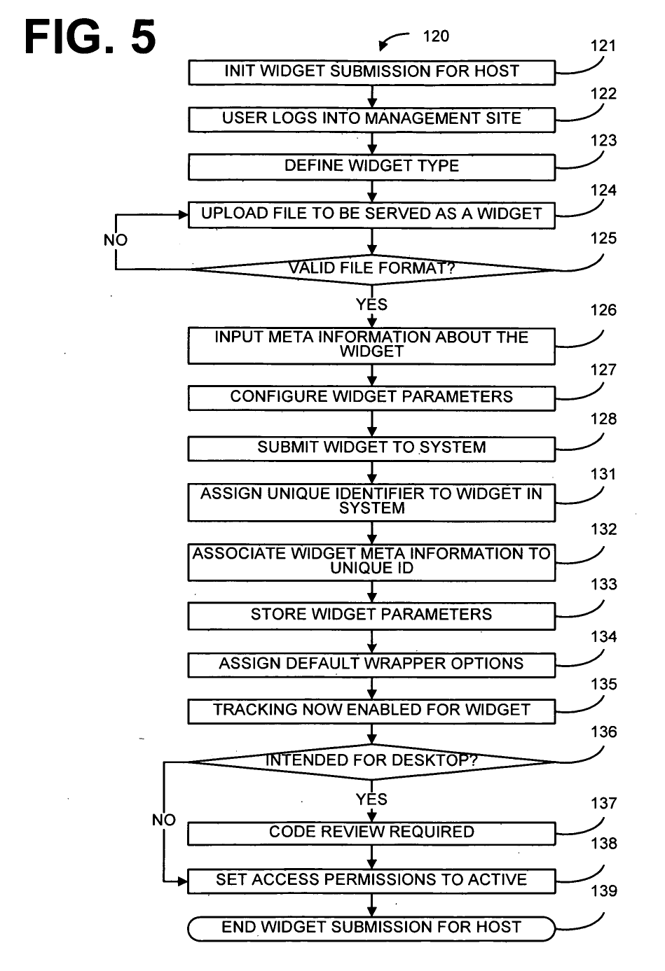

At step 102, the widget system 100 waits to receive an action request. After receiving an action request, the widget system 100 determines what type of action is being requested. At step 103, the widget system 100 determines if an ad widget submission action has been requested. A widget submission action is one where the user on a remote device 15 submits a widget for availability on server 11. If it is determined at step 103 that a widget submission action has not been requested, then the widget system 100 proceeds to step 105. However, if it is determined at step 103 that a widget submission action has been requested, then the widget submission process is performed at step 104. The submission process is herein defined in further detail with regard FIG. 5.

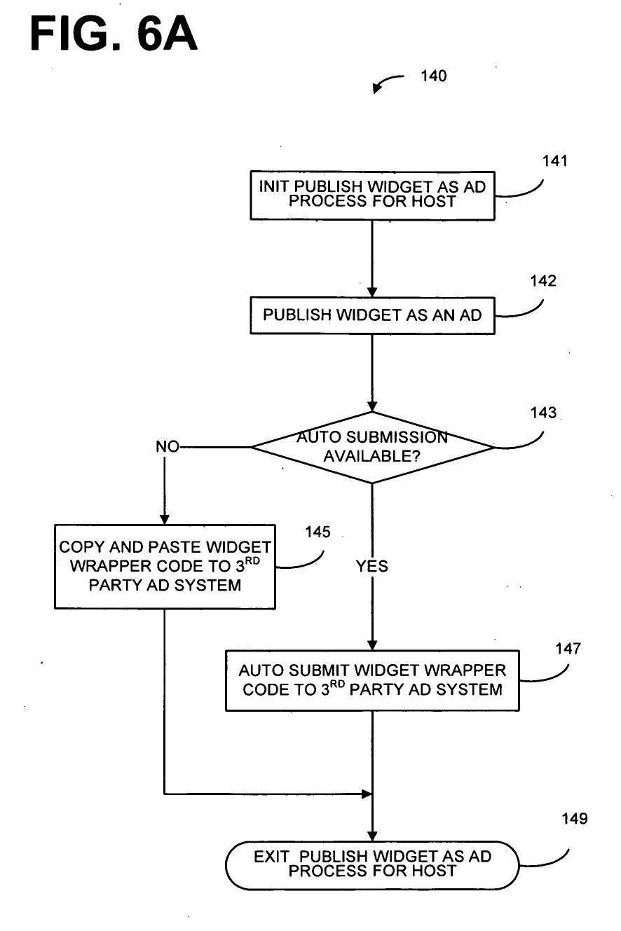

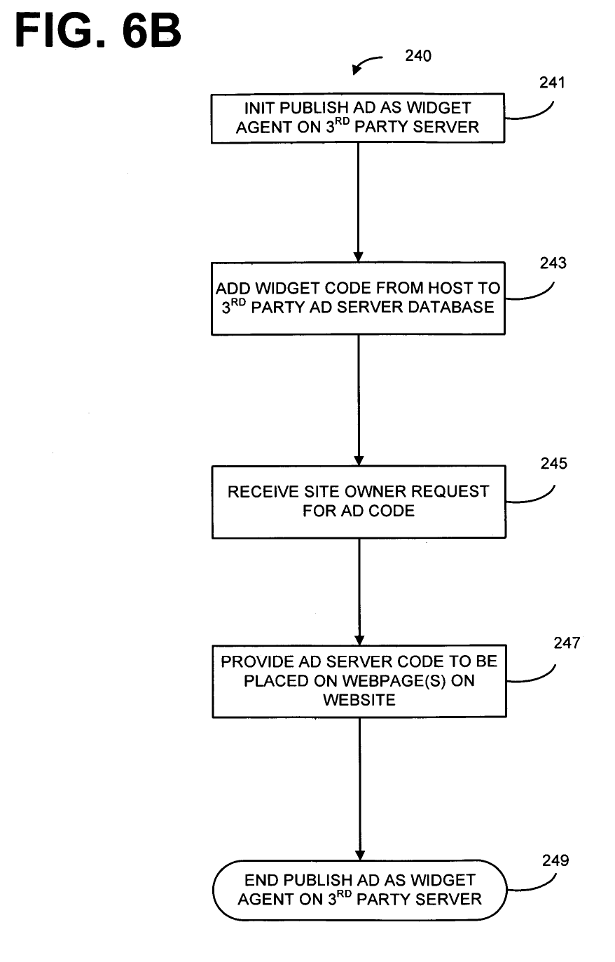

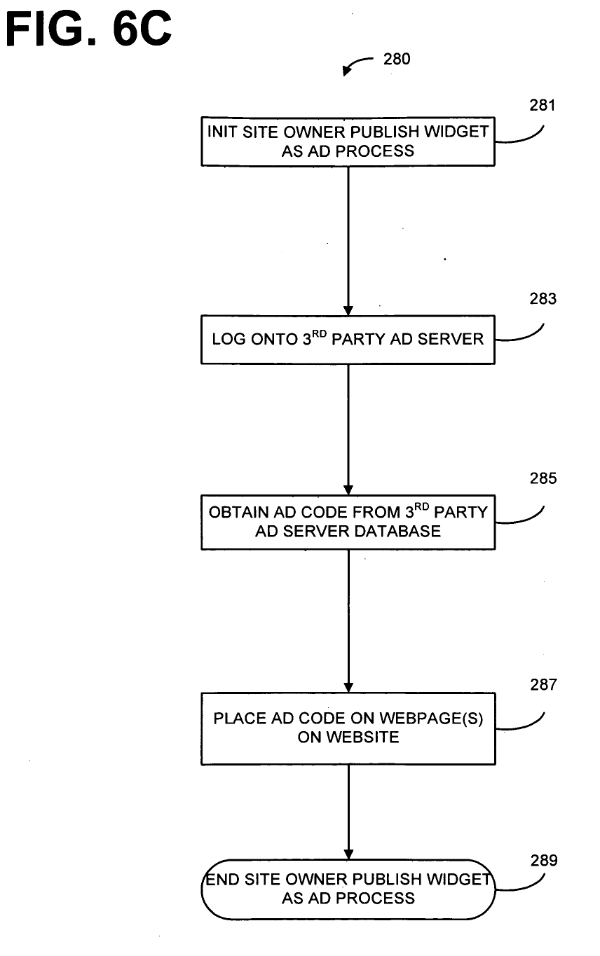

At step 105, the widget system 100 determines if a widget publish action has been requested. A widget publish action is one where a widget is found either on database 12 or on a third parties computer and the user wishes to place it and a third party ad system. If it is determined at step 105 that a widget publish action has not been requested, then the widget system 100 proceeds to step 111. However, if it is determined at step 105 that a widget publish action has been requested, then the publish widget as an ad process is performed at step 106. The publish widget as an ad process is herein defined in further detail with regard FIG. 6A.

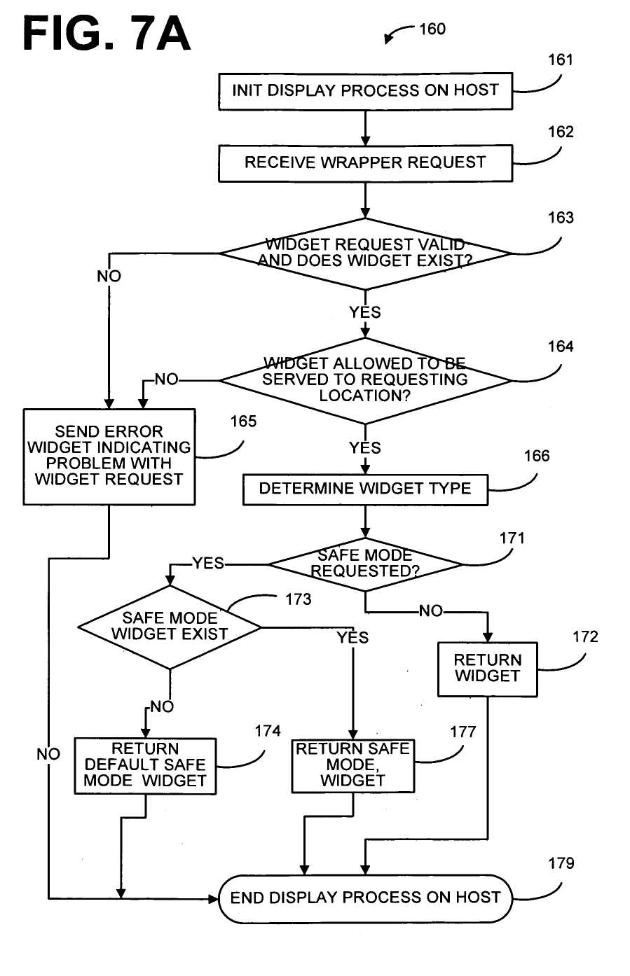

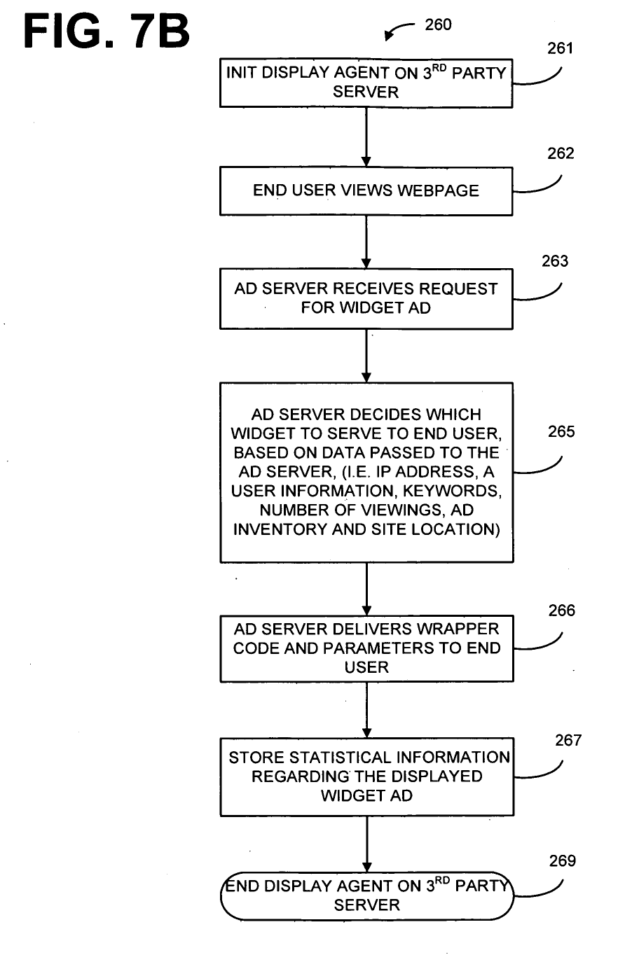

At step 111, the widget system 100 determines if a widget display action has been requested. A widget display action is one where widget system 100 receives a wrapper request from a remote device 15 and downloads component data to the remote device 15. The request received indicates, which particular widget components are downloaded. If it is determined at step 111 that a widget download action has not been requested, then the widget system 100 proceeds to step 113. However, if it is determined at step 111 that a widget display action has been requested, then the widget display process is performed at step 112. The widget download process is herein defined in further detail with regard FIG. 7A.

At step 113, the widget system 100 determines if a base action has been requested. A base action is one where widget system 100 receives a request from a remote device 15 and downloads base program (i.e. remote widget system 200) to the remote device 15. If it is determined at step 113 that a base action has not been requested, then the widget system 100 proceeds to step 115. However, if it is determined at step 113 that a base action has been requested, then the base process is performed at step 114.

At step 115, it is determined if the widget system 100 is to wait for additional action request. If it is determined at step 115 that the widget system is to wait to receive additional actions, then the widget system 100 returns to repeat steps 102 through 115. However, if it is determined at step 115 that there are no more actions to be received, then the widget system 100 then exits at step 119.

FIG. 4B is a flow chart illustrating an example of the operation of the remote widget system 200 of the present invention utilized by the third party ad server 21 or user remote device 15, as shown in FIG. 2B. The remote widget system 200 enables a user on a remote device 15 to place a widget as an ad on a third party ad server 21.

First at step 201, the remote widget system 200 is initialized. This initialization includes the startup routines and processes embedded in the BIOS of the remote device 15. The initialization also includes the establishment of data values for particular data structures utilized in the remote widget system 200.

At step 203, the remote widget system 200 waits to receive an action request. After receiving an action request, the remote widget system 200 determines what type of action is being requested. At step 205, the remote widget system 200 determines if a publish widget as an ad action has occurred. A publish widget as an ad action is one where the user on a remote device 15 submits an ad widget for availability on a third-party ad server illustrated as server 21. If it is determined at step 203 that publish widget as an ad action has not occurred, then the remote widget system 200 proceeds to step 206. However, if it is determined at step 205 that a widget submission action has occurred, then the submission agent is performed at step 206. The submission agent is herein defined in further detail with regard FIG. 6B.

At step 207, the remote widget system 200 determines if a display action has occurred. A display action is one where a widget is found either on database 12 or on a third parties computers and the user wishes to view it on his remote device 15. If it is determined at step 207 that a publish widget as an ad action has not occurred, then the remote widget system 200 proceeds to step 211. However, if it is determined at step 207 that a display widget action has occurred, then the display agent is performed at step 208. The display agent is herein defined in further detail with regard FIG. 7B.

At step 211, the remote widget system 200 determines if a site owner publish widget as an ad process action has occurred. The site owner publish a widget as an ad process is a process that occurs off of the server 11 in remote devices 15, 17-20 or 21. If it is determined at step 211 that site owner publish widget as an ad process action has not occurred, then the remote widget system 200 proceeds to step 213. However, if it is determined at step 211 that a site owner publish widget as an ad process action has occurred, then the site owner publish widget as an ad process is performed at step 212. The site owner publish widget as an ad process is herein defined in further detail with regard FIG. 6C.

At step 213, the remote widget system 200 determines if a base action is to be performed. A base action is one outside the focus of the present application. If it is determined at step 213 that a base action has not occurred, then the remote widget system 200 proceeds to step 215. However, if it is determined at step 213 that a base action has occurred, then the base action is performed at step 214.

At step 215, it is determined if the remote widget system 200 is to wait for additional action request. If it is determined at step 215 that the remote widget system 200 is to wait to receive additional actions, then the remote widget system 200 returns to repeat steps 202 through 215. However, if it is determined at step 215 that there are no more actions to be received, then the remote widget system 200 then exits at step 219.

FIG. 5 is a flow chart illustrating an example of the operation of the widget submission process 120 on the server 11 that is utilized in the widget system 100 of the present invention, as shown in FIGS. 2A and 4A. The widget submission process 120 enables the creation of a widget in storage of that widget in database 12. Once the widget is placed in server 11, it is available for other third-party users. A brief overview of one exemplary process is as follows: 1) is user registered and logged in, if not, require login and/or developer registration; 2) upload files from local machine; 3) Validate and store widget name and meta information; 4) declare widget parameters (i.e. dimensions) and data-types; 5) store for review; 6) widget approval; and 7) done.

First at step 121, the widget submission process 120 is initialized. This initialization includes the startup routines and processes embedded in the BIOS of the server 11. The initialization also includes the establishment of data values for particular data structures utilized in the widget submission process 120.

At step 122, the widget submission process 120 enables a user to login to the management site. At step 123, the widget data type is defined. At step 124, the widget file is stored in a protected folder on the server 11 and its associated information is stored in the database 12 for further review. At step 125, it is determined if the widget file format is valid. A valid widget file format includes, but is not limited to, a swf (i.e. in ActionScript 2 or ActionScript 3), HTML, or JavaScript. If it is determined at step 125 at the widget file format is not valid, then the widget submission process 120 returns to repeat step 124. However, if it is determined at step 125 that the widget file format is valid, then the widget submission process 120 allows input of meta information about the widget at step 126.

At step 127, the widget parameters are configured by the user. The default widget parameters include, but are not limited to, presentation, state and session parameters. The widget is then submitted to server 11, at step 128. At step 131, a unique identifier is assigned to the widget. At step 132, the widget has metadata and parameters associated with the widget's unique ID. The widget parameters and metadata along with a unique identifier are stored in the database 12 at step 133.

At step 134, default wrapper options are assigned to the widget. Now that the default wrapper options are assigned, tracking is enabled for the widget at step 135.

At step 136, it is determined if the widget is intended for desktop usage. If it is determined at step 136 that the widget is not intended for desktop utilization, then the widget submission process 120 skips to step 138. However, if it is determined at step 137 that the widget is intended for operation on a desktop, then the widget requires code review at step 137. This review is performed as a search for errors that include, but is not limited to viruses or malware. Moreover, this review approval process can be automated or through human review.

Upon approval the file is moved to a publicly accessible folder and can be made visible in a gallery by setting access permissions to active at step 138. At step 139, the widget submission process 120 exits.

FIG. 6A is a flow chart illustrating an example of the operation of the publish widget as an ad process 140 on the server 11 that is utilized in the widget system 100 of the present invention, as shown in FIGS. 2A and 4A. The publish widget as an ad process 140 is utilized in order to submit any widget to a third party ad server 21.

First at step 141, the publish widget as an ad process 140 is initialized. This initialization includes the startup routines and processes embedded in the BIOS of the server 11. The initialization also includes the establishment of data values for particular data structures utilized in the publish widget as an ad process 140.

At step 142, the publish widget as an ad process 140 publishes the widget as an ad. In one embodiment, the user would access their management account to select a widget that they wish to publish as an ad.

At step 143, it is determined if the requested action is to auto submit the widget published at step 142. If it is determined at step 143 that the widget is available for auto submission, then the publish ads as a widget process skips the step 147. At this point it is determined if the third party ad server 21, is available for auto submission of a widget as an ad. If it is determined at step 143 that the third-party ad server 21 is not available for auto submission, then the publish widget as an ad process 140 copies and pastes the widget wrapper code to a third-party ad system at step 145. The publish widget as an ad process then proceeds to step 149.

At step 147, the publish widget as an ad process 140 auto submits the widget wrapper code to a third-party ad system 21. At step 139, the publish widget as an ad process 140 then exits.

FIG. 6B is a flow chart illustrating an example of the operation of the publish widget as an ad agent 240 on the third-party ad server 21 that is utilized in the remote widget system 200 of the present invention, as shown in FIGS. 2B and 4B. The publish widget as an ad agent 240 provides the capability for a user on remote device 15 to submit a widget to a third-party ad server 21.

First at step 241, the publish widget as an ad agent 240 is initialized. This initialization includes the startup routines and processes embedded in the BIOS of the third-party ad server 21. The initialization also includes the establishment of data values for particular data structures utilized in the publish widget as an ad agent 240.

At step 243, the publish widget as an ad agent 240 adds widget code from the host server 11 to the database 22 on the third party ad server 21. At step 245, the publish widget as an ad agent 240 receives a site owner request for ad code needed for integration with the third party ad server 21 and the website of the site owner.

At step 247, the added server code is provided to be placed on one or more webpages on the site owner's website.

At step 249, the publish widget as an ad agent 240 then exits.

FIG. 6C is a flow chart illustrating an example of the operation of the site owner publish widget as an ad process 280 on the remote device 15 that is utilized in the remote widget system 200 of the present invention, as shown in FIGS. 2B and 4B. The site owner publish widget as an ad process 280 provides the capability for a website owner on a remote device 15 to serve a widget as an ad on a webpage.

First at step 241, the site owner publish widget as an ad process 280 is initialized. This initialization includes the startup routines and processes embedded in the BIOS of the third-party ad server 21. The initialization also includes the establishment of data values for particular data structures utilized in the site owner publish widget as an ad process 280.

At step 283, the site owner publish widget as an ad process 280 enables an owner to log into a third party ad server 21. At step 285, the site owner publish widget as an ad process 280 obtains the ad code, from the third party ad server database 22, so that the site owner can place the ad code on one or more web pages on the site owner's website at step 287. Once the code is placed, the website is capable of displaying a widget as an ad from the third party ad server 21.

At step 289, the site owner publish widget as an ad process 280 then exits.

FIG. 7A is a flow chart illustrating an example of the display process 160 on the server 11 that is utilized in the widget system 100 of the present invention, as shown in FIGS. 2A and 4A. The display process 160 on server 11 allows the widget system 100 of the present invention to display widget component data on the remote device 15.

First at step 161, the display process 160 is initialized. This initialization includes the startup routines and processes embedded in the BIOS of the server 11. The initialization also includes the establishment of data values for particular data structures utilized in the display process 160. At step 162, the display process 160 receives a wrapper request from a remote device 15 accessing one of the ad widgets.

At step 163, the widget display process 160 checks to see if the widget request is valid and if the widget is enabled for display/download. When the widget is not enabled for display/download or the request is invalid, the user is notified. If it is determined that the widget request is invalid or, if the widget requested does not exist, then the display process 160 skips to step 165. However, if it is determined that the widget request is valid and the widget does exist at step 163, then it is determined if the widget is allowed to be served to the requesting location at step 164. There are cases when the user or location of the user accessing the widget is improper. If it is determined at step 164 that the user or location of the user is not allowed to be served the requested widget, then the display process 160 skips to step 165.

However, if it is determined at step 164 that the user or user location is allowed to receive the requested widget, then the display process 160 skips to step 166 to determine the type of the widget requested.

At step 165, the display process 160 sends an error widget indicating the problem with the widget request and proceeds to step 169 to exit.

At step 166, the display process 160 determines the type of the widget requested. The type of widget requested includes but is not limited to ActionScript 2, ActionScript 3, an express widget, HTML or JavaScript.

At step 171, it is determined if the widget requested is in safe mode. Safe mode is determined from the parameters passed from the ad server 21 to the server 11 to acquire the actual widget. Safe mode is a condition where the widget can display in an alternative manner. This allows an ad sponsor to override the ad criteria for presenting the widget as an advertisement on the remote device. In one embodiment, and there can be multiple advertisements available in the most appropriate advertisement is selected depending upon the ad criteria. The alternative manner may include, but is not limited to alternate widget files, images, or the like. If it is determined at step 171 that the widget requested is in safe mode, then the display process 160 skips the step 173. However, if it is determined at step 171 that the widget requested is not in safe mode, then the display process 160 on host server 11 returns the widget requested at step 172 and then exits at step 179.

At step 173, the display process 160 determines if a safe mode state exists for the widget requested. If it is determined that no safe mode state exists, then the display process 160 returns the default safe mode widget to the user at step 174 and then exits at step 179. However, if it is determined to step 173 that a safe mode state exists for the widget requested, then the display process 160 returns a safe mode widget to the user at step 177 and then exits at step 179.

FIG. 7B is a flow chart illustrating an example of the operation of the display agent 260 on third-party ad server 21 that is utilized in the remote widget system 200 of the present invention, as shown in FIGS. 2B and 4B. The display agent 260 on third-party ad server allows the remote widget system 200 of the present invention to present widget as an ad to users on the remote device 15.

First at step 261, the display agent 260 is initialized. This initialization includes the startup routines and processes embedded in the BIOS of the remote device 15. The initialization also includes the establishment of data values for particular data structures utilized in the display agent 260.

At step 262, an end user views a widget page with ad server code capable of displaying widgets as ads. Upon accessing that widget ad, the remote device 15 sends a request to the third party ad server 21 for the widget ad at step 263.

At step 265, the display agent 260 determines which widget ad to serve to the end user. At display agent 260 determines the space upon the data passed to the third party ad server 21. This data includes but is not limited to the end-user IP address, user information, key words in the ad, a number of viewings of the ad, ad inventory, the site location of the user and the like.

At step 266, the display agent 260 on the third party ad server 21 transmits data for the widget as an ad to the end user. This widget ad data includes but is not limited to, the wrapper code, wrapper parameters and the like.

At step 267, the display agent 260 stores statistical information regarding the widget ad displayed to the end user.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for deploying a requested widget as an advertisement on a remote device, comprising:
determining location of the remote device;
determining if the requested widget to be placed on the remote device exists;
serving the requested widget as an advertisement to the remote device if the location is enabled for the requested widget and the requested widget exists.

2. The method of claim 1, further comprising:
determining the requested widget type of the requested widget.

3. The method of claim 2, further comprising:
determining if an ad sponsor is to override the requested widget for presenting an alternative widget as an advertisement.

4. The method of claim 3, further comprising:
determining if at least one ad parameter for presenting the requested widget indicates that the alternative widget is to be served.

5. The method of claim 4, further comprising:
serving a default widget ad if the alternative widget is not available.

6. The method of claim 1, further comprising:
serving an error widget if the requested widget does not exist.

7. A method for publishing a widget to an advertisement database, comprising:
acquiring widget code from a server;
providing ad server code to be placed on a web page:
creating an advertisement widget by adding the widget code to the advertisement database;
providing ad server code to be placed on a web page; and
deploying the appropriate widget ad code to the web site.

8. The method of claim 7, further comprising:
placing ad server code on a web page; and
determining which advertisement to display on the web page using the ad server code.

9. The method of claim 8, further comprising:
displaying the widget ad on the web page.

10. The method of claim 7, further comprising:
determining if the widget code is received automatically.

11. A system for deploying a requested widget as an advertisement on a remote device, comprising:
means for determining location of the remote device;
means for determining if the requested widget to be placed on the remote device exists;
means for serving the requested widget as an advertisement to the remote device if the location is enabled for the requested widget and the requested widget exists.

12. The system of claim 11, further comprising:
means for determining the requested widget type of the requested widget.

13. The system of claim 12, further comprising:
means for determining if an ad sponsor is to override the requested widget for presenting an alternative widget as an advertisement.

14. The system of claim 13, further comprising:
means for determining if at least one ad parameter for presenting the requested widget indicates that the alternative widget is to be served.

15. The system of claim 14, further comprising:
means for serving a default widget ad if the alternative widget is not available.

16. The system of claim 11, further comprising:
means for serving an error widget if the requested widget does not exist.
